(19) United States
(12) Patent Application Publication
(10) Pub. No.: US 2010/0260952 A1
(43) Pub. Date: Oct. 14, 2010

(54) Furniture bow beam structure and manufacturing method thereof

(76) Inventor: Chia-Wei Chang, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/588,105

(22) Filed: Oct. 5, 2009

(30) Foreign Application Priority Data
Apr. 13, 2009 (TW) 098112141

(51) Int. Cl. B32B 1/00; B27H 1/00; B27M 3/00

(52) U.S. Cl. 428/35.6; 144/381; 428/174

(57) ABSTRACT

A furniture bow beam structure and a manufacturing method thereof. By means of pressing, metal board materials are processed into different assembling members and connecting members. The assembling members and connecting members respectively have curvatures and configurations in conformity with different sections of the beam structure. Each assembling member has an opening that obliquely diverges to one side in width. The connecting member is connected to the opening and mated with the assembling member to form a hollow tubular support. Multiple supports are then connected with each other and rectified to form a complete beam structure with desired curvatures and shapes for connecting with other furniture components.

### BACKGROUND OF THE INVENTION

The present invention relates generally to a furniture bow beam structure and a manufacturing method thereof, and more particularly to a tubular beam structure with different curvatures and varied cross-sectional shapes and a manufacturing method thereof.

Wooden materials are easy to process and have special material characteristics (such as surface stripes and incense). Therefore, wooden materials have been widely applied to common or high-class furniture long since. However, the processing of the wooden materials necessitates higher-level technique so that it is hard to mass-produce wooden furniture. As a result, the manufacturing cost for wooden furniture is high. This fails to meet economic benefit principle. Moreover, it is known that the resources of woods have been rapidly consumed and there is a worldwide trend of environmental protection. Under such circumstance, it's getting harder and harder to acquire some kinds of wooden materials. Therefore, it is a trend to replace wooden materials with other materials (such as plastics and metals) as the main materials of furniture. However, different materials (plastics and metals) have different material performances (such as hardness, elasticity and structural strength). Therefore, the difficulty in processing these materials varies. It is important to find how to overcome the difficulty in processing these different materials instead of wooden materials and achieve not less quality feeling and durability of the furniture.

FIG. 1 shows a traditional wooden chair including a chair seat 601 and a lower support 60 annularly arranged along a periphery of the chair seat 601. One side (rear side) of the chair seat 601 is formed with an arc edge. Multiple downward extending support legs 602 are disposed under the lower support 60. Two L-shaped side supports 50 extend from the straight side of the chair seat 601 to the arc side thereof. A back beam 7 is interconnected between the two side supports 50. The back beam 7 is substantially a bow beam structure. The bottom side of the back beam 7 has multiple connection faces 71 downward connected to the lower support 60. In addition, multiple backboards 73 and side spacer boards 501 with adaptive patterns are respectively disposed between the connection faces 71 and between the side supports 50 and the connection faces 71 to form a complete wooden chair structure. In the above structure, the side supports 50 are connected with the back beam 7 to form a configuration similar to that of the lower support 60 (and the chair seat 601). Accordingly, the backboards 73 and the side spacer boards 501 are obliquely arranged in a gradually upward diverging pattern. Also, in order to meet the requirement of a user for comfortableness when sitting or lying on the chair, the backboards 73 are upward connected to the bottom edge of the back beam 7 in adjacency to the chair seat 601. Therefore, the back beam 7 should have such a structure as shown in FIG. 2 that the edges of two end sections of the back beam 7 are formed with connection faces 71. The connection faces 71 have a cross-sectional shape identical to that of the side supports 50, whereby the back beam 7 can be smoothly connected with the side supports 50. An inner side of a middle section 72 of the back beam 7 is formed with an upward inclined arc face 721 for connecting with the backboards 73. Accordingly, the middle section 72 has a substantially trapezoidal cross-section with a longer lower side and a shorter upper side. (The nonparallel sides of the trapezoid can have a certain inclination angle as necessary). Also, the middle section 72 and the lateral connection faces 71 have different curvatures and cross-sectional shapes. In processing of such shape of wooden materials, the straight wooden blanks are generally baked and heated many times and then curved into a suitable curvature manually or by means of a mold. Then the wooden materials are insert-connected and assembled with each other. Thereafter, the wooden materials are planed, milled and sanded into the desired configuration. Such processing procedure is quite complicated so that the production rate and production efficiency are very low. As a result, it is hard to mass-produce the wooden chairs. Moreover, the wooden materials have become more and more expensive. Therefore, the manufacturing cost for the wooden chair is very high. This fails to meet economic benefit principle and lowers competitive ability.

In the case that the chair structure is mainly made of other materials (such as metals or hard plastics), in consideration of the cost for the materials, the chair structure is preferably composed of hollow tubular components. However, some components in certain positions (such as the back beam 7) have different curvatures (or even three-dimensionally variably extend with the central line or bottom face not positioned on the same plane). Moreover, the respective parts of the back beam 7 may have different structural characteristics with different cross-sectional shapes. In this case, the conventional processing method (such as metal extrusion) is inapplicable. Therefore, it is important to find how to overcome the bottleneck in processing these different materials instead of the wooden materials and how to lower manufacturing cost.

### SUMMARY OF THE INVENTION

It is therefore a primary object of the present invention to provide a manufacturing method of a furniture bow beam. By means of press molding, welding and screw connection, metal board materials are processed into multiple supports with curvatures and configurations in conformity with predetermined sections of the beam structure. The supports are then connected with each other to form a complete beam structure with desired curvatures and shapes. Accordingly, the difficulty and bottleneck in processing metal materials into tubular bodies with different curvatures and cross-sectional shapes can be overcome.

It is a further object of the present invention to provide the above manufacturing method of the furniture bow beam. By this method, the processing procedure of the furniture bow beam structure can be simplified to enhance production efficiency.

It is still a further object of the present invention to provide a furniture bow beam structure, which is made of metal-made tubular structure instead of wooden beam structure so as to lower material cost and enhance competitive ability of the product.

To achieve the above and other objects, the manufacturing method of the furniture bow beam of the present invention includes steps of: cutting board material into assembling member blank, metal board material being cut and processed into an assembling member blank with necessary basic configuration; press molding, the assembling member blank being pressed and processed to form a semi-product of the assembling member with necessary curvature and configuration; cutting board material of connecting member, metal board material being cut into a semi-product of the connecting member with necessary configuration adapted to that of the semi-product of the assembling member; trimming, excessive edge materials of the semi-product of the assembling member and the semi-product of the connecting member being removed to obtain a connecting member with precise size and shape; primarily rectifying, local rebound of the semi-product of the assembling member being rectified to obtain an assembling member with precise curvature, size and shape; assembling, the assembling member and the connecting member being assembled into a support with curvatures and cross-sectional shapes in conformity with a predetermined part of the back beam, different supports being then welded with each other to form a back beam; and secondarily rectifying, the deformation of the back beam resulting from internal stress or external force in the step of assembling being rectified to have precise curvature, size and shape.

The furniture bow beam structure of the present invention is composed of multiple segments of supports, which are connected with each other. The supports at least partially extend at different curvatures. Each two adjacent ends of the supports are formed as open ends with the same curvature, cross-sectional shape and size, whereby the adjacent open ends are connected with each other to form an integrated and smoothly extending beam structure.

The present invention can be best understood through the following description and accompanying drawings wherein:

### BRIEF DESCRIPTION OF THE DRAWINGS

FIG. 1 is a perspective view of a conventional wooden chair;

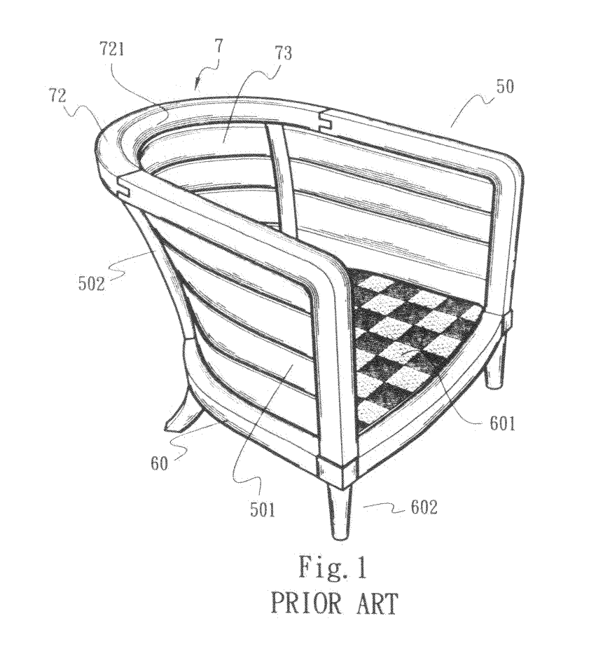

FIG. 2 is a plane view of the back beam structure of the chair of FIG. 1;

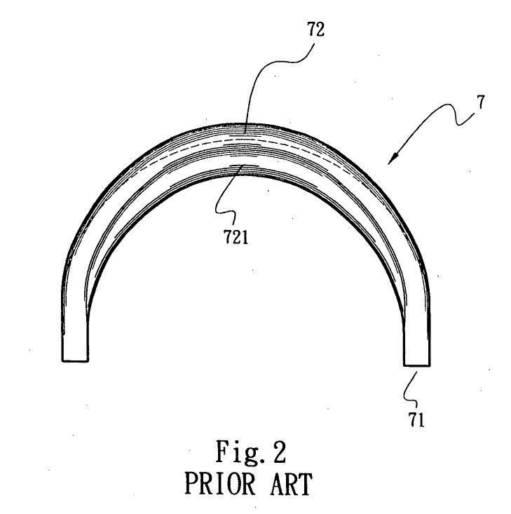

FIG. 3 is a flow chart of the manufacturing method of the present invention;

FIG. 4 is a perspective exploded view of a first embodiment of the present invention;

FIG. 5 is a top view of the first embodiment of the present invention;

FIG. 6 is a perspective assembled view of the first embodiment of the present invention, showing the application thereof;

FIG. 7 is a perspective view according to FIG. 6, showing the appearance of the chair after processed;

FIG. 8 is a perspective exploded view of a second embodiment of the present invention; and

FIG. 9 is a top view of a third embodiment of the present invention.

### DETAILED DESCRIPTION OF THE PREFERRED EMBODIMENTS

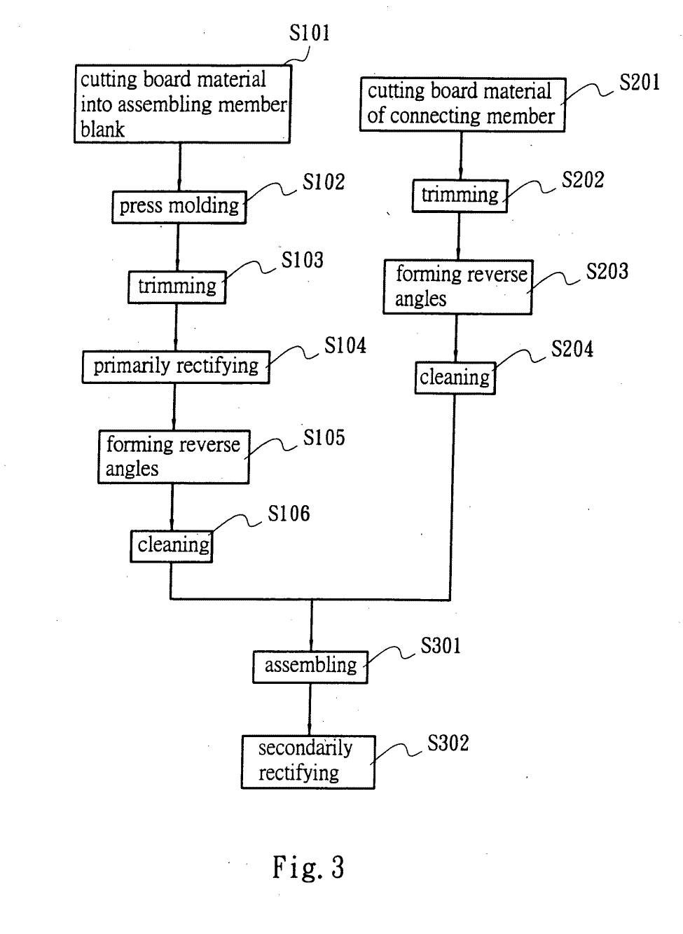

Please refer to FIG. 3. The manufacturing method of the present invention includes step S101 of cutting board material into assembling member blank, step S102 of press molding, step S103 of trimming, step S104 of primarily rectifying, step S105 of forming reverse angles, step S106 of cleaning, step S201 of cutting board material of connecting member, step S202 of trimming, step S203 of forming reverse angles, step S204 of cleaning, step S301 of assembling and step S302 of secondarily rectifying. In step S101 of cutting board material into assembling member blank, metal board material is cut by means of plasma cutting (laser) or any other suitable method to form at least one assembling member blank with necessary basic configuration. In step S102 of press molding, the board material of the assembling member blank is processed by means of an apparatus such as a punch or a press to form a semi-product of the assembling member with U-shaped cross-section and necessary curvature and configuration. In step S103 of trimming, the excessive edge materials of the semi-product of the assembling member are removed by means of a mill or (CNC processing machine). Then, in step S104 of primarily rectifying, the local rebound of the semi-product of the assembling member due to material elasticity is rectified so as to have precise shape and size. Then, in step S105 of forming reverse angles, the sections to be connected are processed, (for example, sanded), to form reverse angles. Finally, in step S106 of cleaning, the surface is cleaned to complete an assembling member with U-shaped cross-section and necessary curvature and configuration. In step S201 of cutting board material of connecting member, the metal board material is cut (in the same manner) to form a plate-like semi-product of the connecting member with desired curvature and configuration. Then, in step S202 of trimming, step S203 of forming reverse angles and step S204 of cleaning, the semi-product of the connecting member is further processed into the connecting member adapted to the assembling member. In step S301 of assembling, by means of welding, screw-connection, adhesion or any other suitable processing measure, the assembling member and the connecting member are assembled into a support structure with curvatures and cross-sectional shapes in conformity with a predetermined part of the back beam. Then, different supports are welded with each other to form a complete back beam. Finally, in step S302 of secondarily rectifying, the deformation resulting from internal stress of thermal expansion/contraction in welding process or external force in screw-connection. Also, the gaps between the connection sections are repaired to have precise size and shape and better appearance and quality feeling.

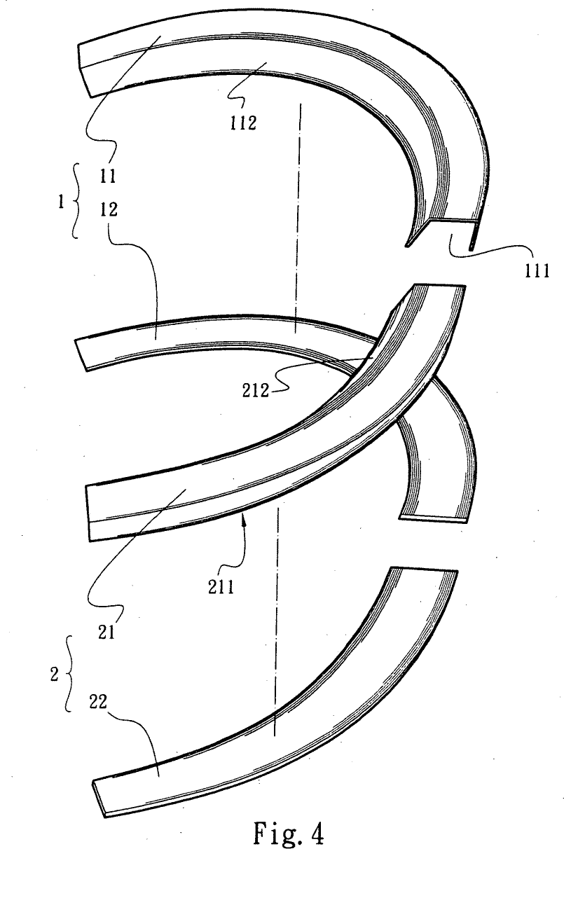

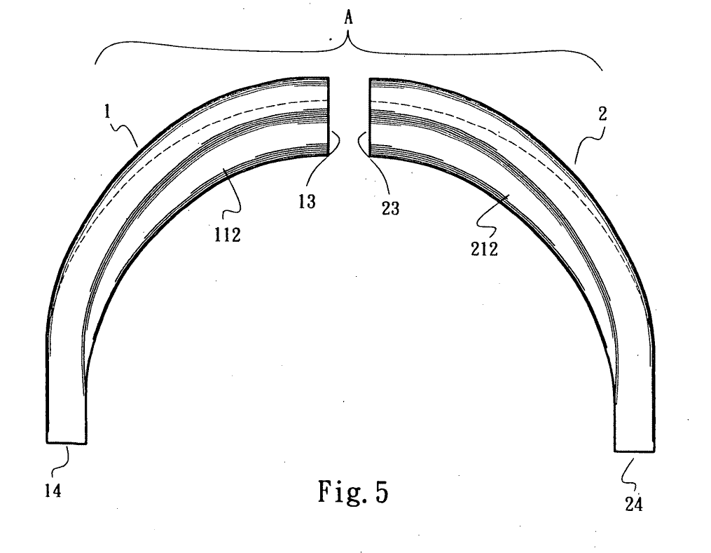

Please refer to FIGS. 4 to 7. The back beam structure A of the present invention is a curved/arc beam member arranged in a specific position on a piece of furniture. (The piece of furniture can be a chair as mentioned in the prior art). The back beam A may three-dimensionally variably extend, (that is, the central line or bottom face is not positioned on the same plane). The respective parts of the back beam A have different structural characteristics with different cross-sectional shapes. In a first embodiment, the back beam A is composed of a first support 1 and a second support 2, which are symmetrically connected with each other. (The first and second supports 1, 2 are manufactured by means of the above method according to different curvatures of two sides of the back beam A. In practice, the number of the supports can be increased or decreased as necessary or in accordance with different structures. In general, the convenience in processing those parts with greater curvatures is taken into major consideration). The first and second supports 1, 2 respectively have symmetric curvatures and varied cross-sectional shapes in conformity with two sides of the back beam A (that laterally extend from the center of the back beam A). The first and second supports 1, 2 are composed of a first assembling member 11, a first connecting member 12, a second assembling member 21 and a second connecting member 22, which are mated and connected with each other. The first and second assembling members 11, 21, (which can be made of metal or any other suitable material), have openings 111, 211 that obliquely diverge to lateral (bottom) side. The first and second connecting members 12, 22 can be respectively fixedly connected to the openings 111, 211 by means of welding (or adhesion). Accordingly, the first and second supports 1, 2 are respectively formed as two hollow tubular bodies each having at least one inclined and curved face 112, 212 on inner side. Two end sections of the first support 1 are respectively formed with two connection open ends 13, 14. Two end sections of the second support 2 are respectively formed with two connection open ends 23, 24. The adjacent connection open ends 13, 23 of the first and second supports 1, 2 are connected with each other (by means of welding or adhesion) to form a complete back beam structure A.

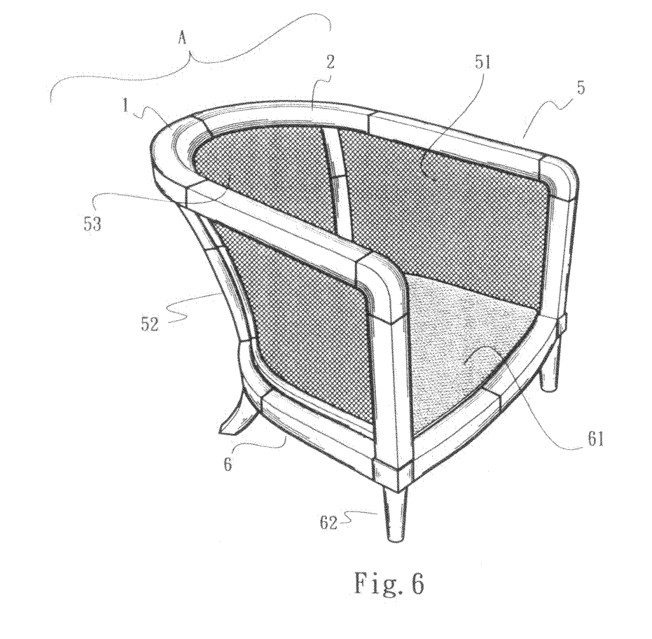

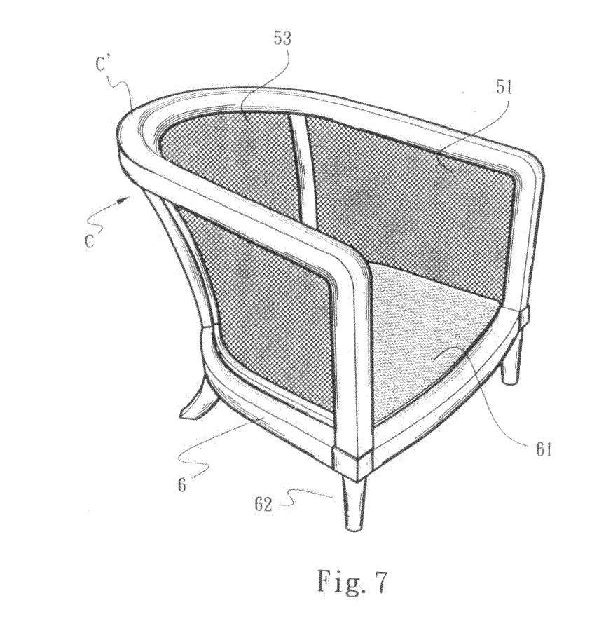

In practice, the connection open ends 14, 24 of the back beam structure A can be connected to two L-shaped side supports 5 respectively. The side supports 5 downward extend to connect with a lower support 6. The lower support 6 is annularly arranged along a periphery of a chair seat 61. Multiple downward extending support legs 62 are disposed under the bottom of the lower support 6. In addition, at least two rear supports 52 are disposed under a middle section of the back beam A. The rear supports 52 downward extend to connect with the lower support 6 so as to form a frame body C of the chair. Side spacer members 51 are distributed between the side supports 5 and the lower support 6. In addition, back spacer members 53 are disposed between the two rear supports 52 to form a non-wooden chair structure (as shown in FIG. 6). When processing the frame body structure C composed of the side supports 5, the lower support 6, the rear supports 52 and the back beam A, a suitable filler can be filled into the gaps between the supports and the connection sections of the back beam A. Then, a suitable paint C′ is sprayed onto the surface (as shown in FIG. 7) to enhance the appearance and quality feeling of the product.

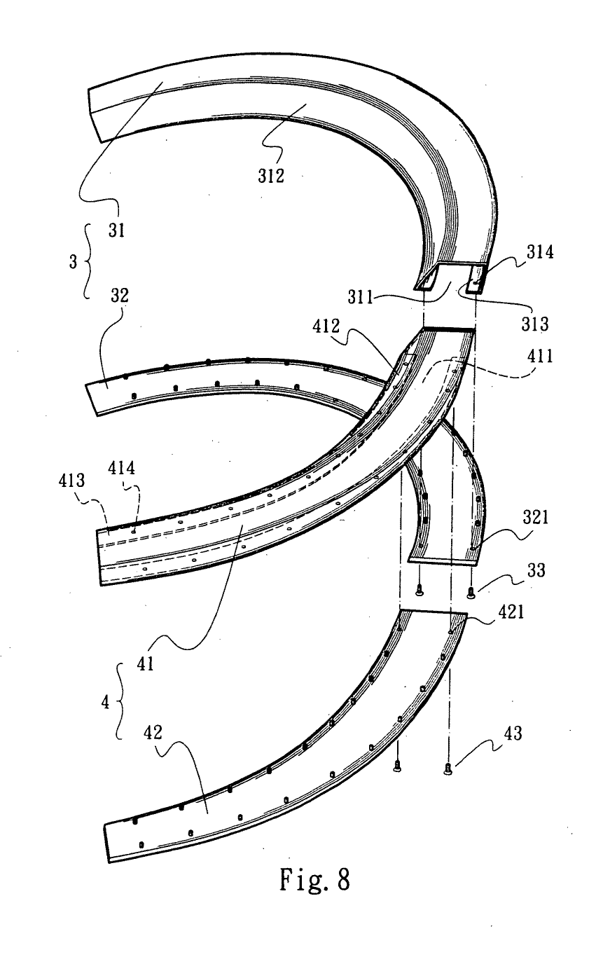

FIG. 8 shows a second embodiment of the back beam structure B of the present invention. In this embodiment, the back beam structure B is composed of a first support 3 and a second support 4, which are symmetric with each other. The first and second supports 3, 4 basically have the same symmetric curvatures and varied cross-sectional shapes as the first and second supports 1, 2. The only difference therebetween is that the first and second supports 3, 4 are composed of a first assembling member 31, a first connecting member 32, a second assembling member 41 and a second connecting member 42, which are mated and connected with each other. The first and second assembling members 31, 41 have openings 311, 411 that obliquely diverge to lateral (bottom) side. Two inner flanges 312, 412 are respectively disposed on two lateral edges of each opening 311, 411. Multiple fixing holes 313, 413 are respectively formed on the flanges 312, 412. Multiple through holes 321, 421 are respectively formed on two lateral edges of the first and second connecting members 32, 42 in alignment with the fixing holes 313, 413. Multiple fixing members 33, 43 are passed through the through hole 321, 421 and locked in the fixing holes 313, 413 to connect the first and second assembling members 31, 41 with the first and second connecting members 32, 42 to form the first and second supports 3, 4. (The fixing members 33, 43 can be rivets or bolts. In the case that the fixing members 33, 43 are bolts, the fixing holes 313, 413 are threaded holes). The first and second supports 3, 4 are then connected with each other to form the back beam B. In this embodiment, the first and second assembling members 31, 41 are connected with the first and second connecting members 32, 42 by means of riveting or screw connection to form an aspect different from the first embodiment.

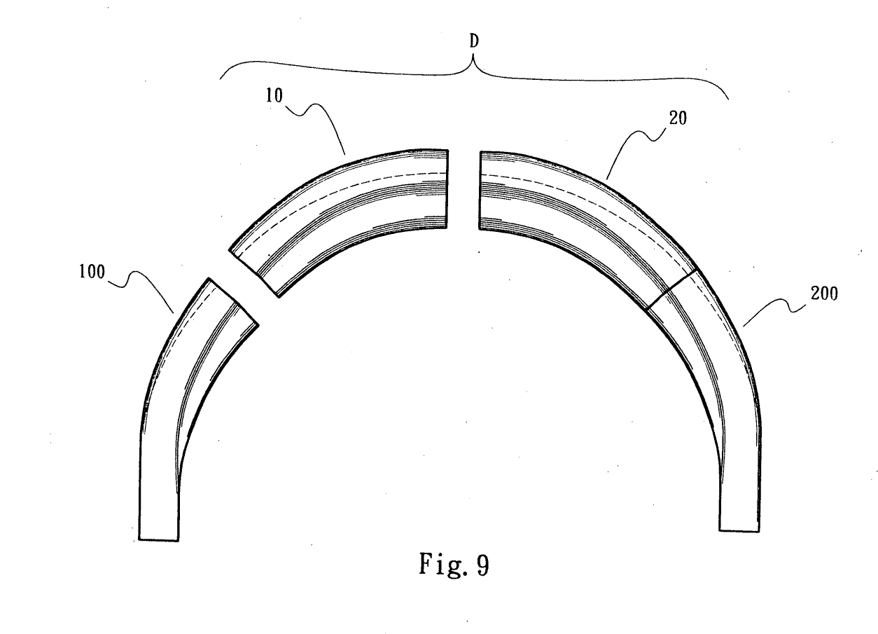

FIG. 9 shows a third embodiment of the back beam D of the present invention. In practical manufacturing process, in the case that the back beam D has smaller curvature radius or radian than the back beams A and B, the back beam D will have greater variation per unit length. In this case, the back beam D can be composed of two pairs of shorter assembling supports 10, 100 and 20, 200, which are symmetric with and connected to each other. The assembling supports 10, 100 are connected to form the same structure as the first support 1 (or 3). The assembling supports 20, 200 are connected to form the same structure as the second support 2 (or 4). Accordingly, the difficulty in manufacturing those components with more complicated configuration or greater variation can be overcome to enhance the quality of the product.

The back beam structure of the present invention can be made of metal or any other suitable material instead of wooden material so as to reduce material cost and meet the requirements of environmental protection. Moreover, the back beam can be composed of a certain number of supports, (for example, four, three or two supports), in accordance with different curvatures or radians. Therefore, the structure is simplified and the processing procedure is facilitated so as to increase production efficiency and enhance competitive ability of the product.

The above embodiments are only used to illustrate the present invention, not intended to limit the scope thereof. Many modifications of the above embodiments can be made without departing from the spirit of the present invention.

What is claimed is:

1. A furniture bow beam structure composed of multiple segments of supports, which are connected with each other, the supports at least partially extending at different curvatures, each two adjacent ends of the supports being formed as open ends with the same curvature, cross-sectional shape and size, whereby the adjacent open ends are connected with each other to form an integrated and smoothly extending beam structure.

2. The furniture bow beam structure as claimed in claim 1, wherein each support is composed of an assembling member and a connecting member, the assembling member having a half-closed elongated cover member with an opening that obliquely diverge to one side in width, the connecting member being connected to the opening and mated with the assembling member to form a hollow tubular body.

3. The furniture bow beam structure as claimed in claim 2, wherein the assembling member and the connecting member are fixedly connected with each other by means of welding.

4. The furniture bow beam structure as claimed in claim 2, wherein flanges are respectively disposed on two lateral edges of the opening of the assembling member, multiple fixing holes being respectively formed on the flanges, multiple through holes being respectively formed on two lateral edges of the connecting member, multiple fixing members being passed through the through hole and locked in the fixing holes to connect the assembling member with the connecting member.

5. The furniture bow beam structure as claimed in claim 4, wherein the fixing holes are threaded holes and the fixing members are bolts.

6. The furniture bow beam structure as claimed in claim 4, wherein the fixing members are rivets.

7. The furniture bow beam structure as claimed in claim 1, wherein bottom face of the beam structure extends with varied curvatures.

8. The furniture bow beam structure as claimed in claim 2, wherein bottom face of the beam structure extends with varied curvatures.

9. The furniture bow beam structure as claimed in claim 1, wherein the supports are respectively formed with different cross-sectional shapes.

10. The furniture bow beam structure as claimed in claim 2, wherein the supports are respectively formed with different cross-sectional shapes.

11. A manufacturing method of a furniture bow beam, comprising steps of:
cutting board material into assembling member blank, metal board material being cut and processed into an assembling member blank with necessary basic configuration;
press molding, the assembling member blank being pressed and processed to form a semi-product of the assembling member with necessary curvature and configuration;
cutting board material of connecting member, metal board material being cut into a semi-product of the connecting member with necessary configuration adapted to that of the semi-product of the assembling member;
trimming, excessive edge materials of the semi-product of the assembling member and the semi-product of the connecting member being removed to obtain a connecting member with precise size and shape;
primarily rectifying, local rebound of the semi-product of the assembling member being rectified to obtain an assembling member with precise curvature, size and shape;
assembling, the assembling member and the connecting member being assembled into a support with curvatures and cross-sectional shapes in conformity with a predetermined part of the back beam, different supports being then welded with each other to form a back beam; and
secondarily rectifying, the deformation of the back beam resulting from internal stress or external force in the step of assembling being rectified to have precise curvature, size and shape.

12. The manufacturing method of the furniture bow beam as claimed in claim 11, further comprising a step of forming reverse angles before the step of assembling, in which the sections of the assembling member and the connecting member that are to be connected are sanded to form reverse angles.

13. The manufacturing method of the furniture bow beam as claimed in claim 12, further comprising a step of cleaning after the step of forming reverse angles, in which the surfaces of the assembling member and the connecting member are cleaned.

14. The manufacturing method of the furniture bow beam as claimed in claim 11, wherein in the step of assembling, the assembling member and the connecting member are assembled by means of welding, screw-connection or adhesion.

15. The manufacturing method of the furniture bow beam as claimed in claim 12, wherein in the step of assembling, the assembling member and the connecting member are assembled by means of welding, screw-connection or adhesion.

16. The manufacturing method of the furniture bow beam as claimed in claim 13, wherein in the step of assembling, the assembling member and the connecting member are assembled by means of welding, screw-connection or adhesion.

17. The manufacturing method of the furniture bow beam as claimed in claim 11, wherein in the step of secondarily rectifying, the gaps between the connection sections are also repaired.

18. The manufacturing method of the furniture bow beam as claimed in claim 12, wherein in the step of secondarily rectifying, the gaps between the connection sections are also repaired.

19. The manufacturing method of the furniture bow beam as claimed in claim 13, wherein in the step of secondarily rectifying, the gaps between the connection sections are also repaired.

20. The manufacturing method of the furniture bow beam as claimed in claim 14, wherein in the step of secondarily rectifying, the gaps between the connection sections are also repaired.

21. The manufacturing method of the furniture bow beam as claimed in claim 11, wherein in the step of cutting board material into assembling member blank, the metal board material is cut by means of plasma cutting.

22. The manufacturing method of the furniture bow beam as claimed in claim 12, wherein in the step of cutting board material into assembling member blank, the metal board material is cut by means of plasma cutting.

23. The manufacturing method of the furniture bow beam as claimed in claim 13, wherein in the step of cutting board material into assembling member blank, the metal board material is cut by means of plasma cutting.

24. The manufacturing method of the furniture bow beam as claimed in claim 14, wherein in the step of cutting board material into assembling member blank, the metal board material is cut by means of plasma cutting.

25. The manufacturing method of the furniture bow beam as claimed in claim 17, wherein in the step of cutting board material into assembling member blank, the metal board material is cut by means of plasma cutting.
